(19) United States
(12) Patent Application Publication
(10) Pub. No.: US 2012/0054127 A1
(43) Pub. Date: Mar. 1, 2012

(54) Method and system for providing an automobile auction vehicle spotting and inspection guarantee service

(76) Inventors: James Richard Sibel, Hartleysville, PA (US); Robert Mark Hollenshead, Exton, PA (US)

(21) Appl. No.: 13/136,043

(22) Filed: Jul. 22, 2011

Related U.S. Application Data
(60) Provisional application No. 61/344,610, filed on Aug. 30, 2010.

(51) Int. Cl. G06Q 90/00

(52) U.S. Cl. 705/500

(57) ABSTRACT

Methods and systems are provided that provide a vehicle spotter service, which includes a vehicle inspection, vehicle history report and other vehicle information concerning the condition of a vehicle, requested by a potential purchaser of a vehicle at an automobile auction in order to facilitate the decision of the potential purchaser to purchase or not to purchase the vehicle. The exemplary method includes an optional guarantee that vehicle spotter services requested by a potential purchaser of a vehicle at an auto auction are accurate and do not contain any material errors. The exemplary method further includes determining, when the potential purchaser elects the optional guarantee and relies on the vehicle spotter service in the purchase of the vehicle, if the vehicle history report or other vehicle information provided contain any inaccurate information or material errors; and, when it is determined that an inaccuracy or material error in the vehicle history report or other vehicle information provided was relied on by the potential purchaser to purchase the vehicle, providing a guarantee to purchase the vehicle from the potential purchaser for the amount paid for the vehicle at auction.

### FIELD

The disclosed embodiments relate to a process for guaranteeing and backing the accuracy of vehicle inspection and vehicle history report services used for vehicle spotting services located at a wholesale auto auctions and relied upon by purchasers of vehicles at auctions.

### BACKGROUND

On-site vehicle inspection and vehicle history report services, called vehicle spotter services, prepare and provide inspection and evaluation services on used vehicles located at auto auctions and use information gathered through those inspections and evaluations to provide potential purchasers of those vehicles with vehicle inspection and vehicle history reports, and answer specific questions about the vehicles which are posed by the potential purchasers, in order to aid those potential purchasers in determining whether to bid on certain vehicles at the auction in an attempt to purchase those vehicles. These services, performed by a vehicle spotter, identify and locate a specific vehicle at an auto auction and inspect the vehicle at the request of a potential purchaser and use information about the vehicle to prepare vehicle inspection and vehicle history reports and answer any specific questions the potential purchaser may have about the vehicle.

Potential purchaser then uses these reports and information to determine the condition of the vehicle in order to determine whether to bid on a vehicle at auction in an attempt to purchase the vehicle, and how much money the potential purchaser is willing to pay for the vehicle. The potential purchaser relies on these vehicle inspection and vehicle history report services in evaluating whether specific vehicles are marketable in its business and whether to invest in these specific assets. If a material error exists in a vehicle inspection or vehicle history report done by a vehicle inspection and vehicle history report service provider for a potential purchaser, and the potential purchaser relies on that information containing a material error in purchasing a vehicle, the potential purchaser has no redress against the vehicle inspection and vehicle report service for the material error relied upon in purchasing the vehicle.

One on-site vehicle inspection and vehicle report service provider has provided potential purchasers with an optional guarantee that its vehicle inspection and vehicle history report services are accurate. For instance, Provisional Application for Patent, Application No. 61/344,610, the disclosure of which is incorporated herein in its entirety by reference, describes a vehicle inspection and vehicle history report service that provides potential purchasers with a guarantee that the vehicle inspection done and the vehicle history report provided will be free of material error. If a potential purchaser elects the optional guarantee and relies upon the vehicle information and vehicle history report provided by the vehicle information and vehicle history report service provider, the vehicle inspection and vehicle report guarantor (hereinafter “spotter service guarantor”) will purchase the vehicle back from the potential purchaser at the same purchase price the potential purchaser paid for the vehicle at the automobile auction when there is a material error in the information contained in the vehicle history report or other information provided to the potential purchaser by the vehicle spotter service provider.

### SUMMARY

Embodiments disclosed herein provide methods and systems that provide an optional guaranteed vehicle inspection and vehicle history report service on which a potential purchaser may rely when bidding on vehicles online or in person at an automobile auction. The exemplary methods and systems provide an optional guarantee under which a vehicle purchased by a potential purchaser in reliance on a material error contained in the vehicle inspection and vehicle history report or other information provided to the potential purchaser by the vehicle inspection and vehicle report service provider, will be purchased back from that potential purchaser by a spotter service guarantor at the same purchase price the potential purchaser paid for the vehicle at the automobile auction.

### BRIEF DESCRIPTION OF THE DRAWINGS

FIG. 1 is a block diagram illustrating an exemplary environment; and

FIG. 2 is a process flow chart illustrating exemplary steps performed by a vehicle spotter when a vehicle inspection and vehicle history report service is requested by a potential purchaser.

### DETAILED DESCRIPTION

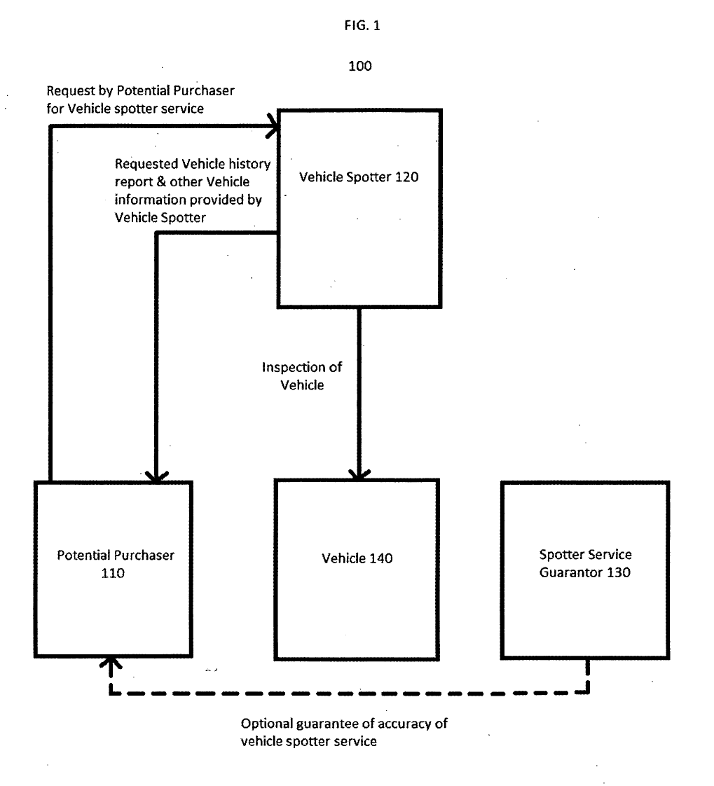

FIG. 1 is a block diagram illustrating an exemplary environment 100 in which methods and systems of the present disclosure may be implemented. Environment 100 portrays exemplary relationships between a potential purchaser 110 of a vehicle, a vehicle spotter 120, a spotter service guarantor 130 and a vehicle 140 in some of the embodiments disclosed herein. Potential purchaser 110 may be an individual or a vehicle dealer that purchases vehicles at auction and sells them to consumers. Vehicle spotter 120 may be an individual or a business entity that provides a vehicle inspection and vehicle history report service to potential purchasers, such as potential purchaser 110. Spotter service guarantor 130 can be an individual or a business entity. A vehicle 140 can be any vehicle that is for sale at auction.

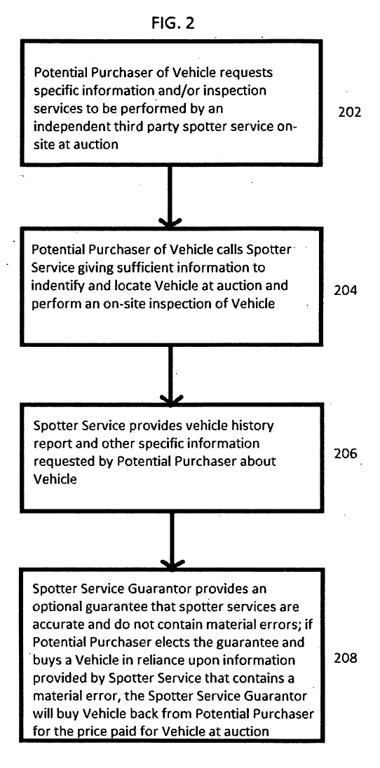

FIG. 2 is a process flow chart illustrating exemplary steps performed by the vehicle spotter 120 when a vehicle inspection and vehicle history report service is requested by a potential purchaser 110 for a vehicle 140. Potential purchaser 110 and vehicle spotter 120 may communicate using a telephone or via electronic communication. When potential purchaser 110 desires specific information about a vehicle 140 or inspection services on that vehicle 140 to be performed by an independent third party on vehicle spotter 120's behalf on-site at auction or in advance at auction, potential purchaser 110 contacts vehicle spotter 120 on a telephone via a toll free telephone number or other telephone number, or by other means of electronic communication (e.g., email, webpage, information messages, etc.) (Step 202) and provides vehicle spotter 120 with sufficient information to identify vehicle 140 (Step 204). Vehicle spotter 120 then identifies and locates the vehicle 140 and performs an on-site inspection of the vehicle 140. Vehicle spotter 120 then provides a vehicle history report on the vehicle 140 to potential purchaser 110 based on information the vehicle spotter 120 compiles from the on-site vehicle inspection of the vehicle 140 (Step 206).

Potential purchaser 110 may ask vehicle spotter 120 specific questions about the vehicle 140, and vehicle spotter 120 will answer those questions based on information compiled from the on-site vehicle inspection of the vehicle 140 and vehicle history report prepared on the vehicle 140. Communication between potential purchaser 110 and vehicle spotter 120 can be made via telephone on a toll free telephone number or other telephone number, or via electronic communication (e.g., email, webpage, information messages, etc.). That communication between the potential purchaser 110 and vehicle spotter 120 will be recorded and/or saved for future reference and use.

Potential purchaser 110 has the option of electing a guarantee for an additional fee that the vehicle information and vehicle history report provided by the vehicle information and vehicle history report service provider is accurate. If Potential purchaser 110 chooses this option, a spotter service guarantor 130 will back the accuracy of the vehicle inspection and vehicle history report with a promise to buy the vehicle 140 back from potential purchaser 110 if there is any material error contained in the vehicle information and/or vehicle history report provided by the vehicle inspection and vehicle history report service provider, and the potential purchaser 110 has relied on this material error in the vehicle information and/or vehicle history report in purchasing the vehicle 140.

If the potential purchaser 110 elects the vehicle information and vehicle history report service accuracy guarantee, the spotter service guarantor 130 receives the vehicle information (including communication between potential purchaser 110 and vehicle spotter 120) and vehicle history report on the vehicle 140 from the vehicle spotter 120. The spotter service guarantor 130 then provides a guarantee that that vehicle information and vehicle history report on the vehicle 140 provided to potential purchaser 110 by vehicle spotter 120 is accurate and without material error, and is a reflection of the true condition of the vehicle 140. If the potential purchaser 120 decides to purchase the inspected vehicle. 140, the spotter service guarantor 130 provides the potential purchaser 110 a guarantee that if there is any material error contained in the vehicle information and/or vehicle history report provided by the vehicle spotter 120 on which the potential purchaser 110 relied in purchasing the vehicle 140, the spotter service guarantor 130 will purchase the vehicle 140 back from potential purchaser 120 for the same purchase amount that potential purchaser 110 paid for the vehicle 140 at auction (Step 208).

As disclosed herein, embodiments and features can be implemented through methods and systems. Such embodiments can be implemented in various environments, such as networked and computer-based environments with one or more users. The disclosed embodiments, however, are not limited to such examples, and the embodiments can be implemented with other platforms and on other environments.

Other embodiments of the invention will be apparent to those skilled in the art from consideration of the specification and practice of the embodiments disclosed herein. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. An independent third party vehicle spotter service with an optional guarantee provided by a spotter service guarantor backing the accuracy of the vehicle inspection and vehicle history report prepared by the vehicle spotter, comprising:
receiving a request to inspect a particular vehicle located at an auto auction;
identifying and locating the vehicle at auction using information provided by the potential purchaser of the vehicle requesting the service;
inspecting the vehicle to determine its condition and history;
determining the vehicle condition and vehicle history;
preparing a vehicle history report for the potential purchaser highlighting the vehicle condition;
providing said vehicle history report and other requested information to the potential purchaser of the vehicle.

2. The method of claim 1, wherein:
The spotter service request is initiated by a potential purchaser;
vehicle history report and other vehicle information provided by the vehicle spotter facilitates the potential purchaser's decision to purchase or not to purchase a specific vehicle based on an independent third party's assessment of the vehicle's condition; and
the potential purchaser decides to purchase the vehicle.

3. The method of claim 2, wherein the potential purchaser elects an optional guarantee whereby the accuracy and reliability of the vehicle history report and other vehicle information provided to the potential purchaser is guaranteed by a spotter service guarantor, wherein:
if the potential purchaser decides to purchase the vehicle based on the vehicle history report and other information provided by the spotter service; and
if the parties determine there is a material error or inaccuracy contained in the vehicle history report prepared by the vehicle spotter or other information provided to the purchaser by the vehicle spotter;
the spotter service guarantor will purchase the vehicle from the potential purchaser for the same amount purchaser paid for the vehicle at auction.

4. The method of claim 3, wherein the determination of purchasing the vehicle from the potential purchaser that purchased the vehicle at auction includes:
receiving a request from the potential purchaser that purchased the vehicle for an exercise of the guarantee purchase option from the guarantor;
determining that the potential purchaser elected the guarantee that the vehicle information and vehicle history report provided was accurate;
determining that the potential purchaser did purchase the vehicle;
determining that there was a material error or inaccuracy in the vehicle history report or other vehicle information provided by the vehicle spotter to the potential purchaser;
determining that the potential purchaser relied on the vehicle history report or other information on the vehicle provided by the vehicle spotter service;
determining the purchase price of vehicle at auction paid by potential purchaser;
purchasing the vehicle from the potential purchaser that purchased the vehicle at auction for the same purchase price paid by potential purchaser.
